(19) United States
(12) Patent Application Publication
(10) Pub. No.: US 2013/0290213 A1
(43) Pub. Date: Oct. 31, 2013

(54) SYSTEM AND METHOD FOR MANAGING EVENTS FOR A FACILITY

(71) Applicant: Gregory Stewart Deasaro, Spring, TX (US)

(72) Inventor: Gregory Stewart Deasaro, Spring, TX (US)

(73) Assignee: Hotel DNA

(21) Appl. No.: 13/460,389

(22) Filed: Apr. 30, 2012

(51) Int. Cl. G06Q 10/06

(52) U.S. Cl. 705/345

(57) ABSTRACT

A system and method for managing events. A report of a problem is received from an authorized user. A new event is created logging the problem in response to receiving submission of the new event. The new event is saved in a database in response to receiving submission of the new event from the authorized user. The new event includes at least information about a location of a problem, a department assigned the event, an event code, and a contact method for one or more users associated with the new event. An alert is sent utilizing the contact method to notify the one or more users associated with the new event. Updated information is received regarding the new event. The updated information is saved in the database as associated with the new event.

### BACKGROUND

The use of and development of communications has grown nearly exponentially in recent years. The growth is fueled by new and enhanced devices, larger networks with more reliable protocols, and better communications hardware and software available to service providers and consumers. Various industries have struggled to keep pace with these advancements. For example, event management providers, such as hotels, amusement parks, and concert organizers have struggled to move beyond tracking information utilizing log notebooks, radios, spreadsheets, or documents.

### SUMMARY

One embodiment provides a system and method for managing events. A report of a problem may be received from an authorized user. A new event may be created logging the problem in response to receiving submission of the new event. The new event may be saved in a database in response to receiving submission of the new event from the authorized user. The new event may include at least information about a location of a problem, a department assigned the event, an event code, and a contact method for one or more users associated with the new event. An alert may be sent utilizing the contact method to notify the one or more users associated with the new event. Updated information may be received regarding the new event. The updated information may be saved in the database as associated with the new event.

Another embodiment provides a system for managing events. The system may include a server configured to interface with a website or applications installed on multiple of electronic devices. The server may be configured to receive a report of a problem from an authorized user, create a new event associated with the problem in response to the authorized user submitting the new event, new event including at least information about a location of a problem, a department assigned the event, an event code, and a contact method for one or more users associated with the new event, and send an alert utilizing the contact method to notify the one or more users associated with the new event. The system may also include at least one database in communication with the server. The database may be configured to store the new event in the database in response to receiving submission of the new event from the authorized user, wherein the at least one database stores updates for the new event in response to submission through the website or applications.

Another embodiment includes a server for managing events. The server includes a processor for executing a set of instructions and a memory for storing the set of instructions. The set of instructions may be configured to receive a report of a problem from an authorized user, create a new event logging the problem in response to receiving submission of the new event, save the new event in a database in response to receiving submission of the new event from the authorized user, the new event including at least information about a location of a problem, a department assigned the event, an event code, and a contact method for one or more users associated with the new event, send an alert to notify the one or more users associated with the new event, the alert, receive updated information regarding the event; and save the updating information as associated with the event.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a communications system for managing events in accordance with an illustrative embodiment;

FIG. 2 is a pictorial representation of an event management system in accordance with an illustrative embodiment;

FIG. 3 is a flowchart of a process for managing events in accordance with an illustrative embodiment;

FIGS. 4-5 are a pictorial representation of graphical user interfaces 400 and 500 in accordance with an illustrative embodiment;

FIGS. 6-8 are pictorial representations of graphical user interfaces in accordance with an illustrative embodiment.

### DETAILED DESCRIPTION OF THE DRAWINGS

The illustrative embodiments provide a system, method, and computer program product for managing events. The events may be managed for any number of facilities, buildings, campuses, organizations, collaborations, exposition, conference, gatherings, meeting, happenings, or service providers (hereinafter referred to as a “service provider” or “facility”). For example, a facility may be a hotel, and a conference may be a technical conference with thousands of participants. Various examples, are given with regards to hotels for purposes of simplicity, but the described embodiments are equally applicable to any number of events and service providers.

In one embodiment, the event is a logged report of a problem, task, or issue (hereinafter referred to as an “event”) that needs to be completed, addressed, or otherwise resolved for a service provider. The event may escalate from a reported problem, incident, task, or issue in response to being electronically submitted, verified, and/or documented. For example, an event may be submitted through electronic reporting that a heater is broken in the hotel room of a customer. Individuals or groups that report an event or require help may be employees, administrators, clerks, users, guests, customers, parties, or so forth.

In one embodiment, the system utilizes a cloud-based server management system for managing events. The system may be web-based allowing authorized users to generate and access events and other information at their convenience. The information associated with each event may be stored in a centralized database that allows multiple users to track events from initial reporting as a problem or incident to final resolution. The system may also be utilized to send out reporting alerts including relevant information to designated users to ensure that the problem is quickly resolved. Alerts, messages, or notifications may also be communicated to the users in response to the new event being updated with new information or in response to the status changing, such as from active to completed.

The system may allow commonly available communications devices or platforms, such as smart phones, cell phones, iPods, and tablet computers, to be utilized instead of customized hardware or devices. For example, the communications device may only require an application and network connection to report, track, manage, and report on events and otherwise perform the illustrative embodiments. In most cases, individuals already have access to a personal communications or communications device that may be utilized to serve multiple purposes. For example, the service provider may even pay for all or part of the cost of a smart phone and service so that the user may utilize a personal device.

As a result, the system and method herein described help manage events before they become potential liabilities or issues for the service provider at a decreased cost, with less involvement, and with better reporting. The systems and methods herein described are easy to learn and use and simplify the sometimes complex nature of the event tracking. In addition, utilization of cloud-based and web-based servers provides additional reliability, better backup, data duplication, and a cheaper cost for each service provider.

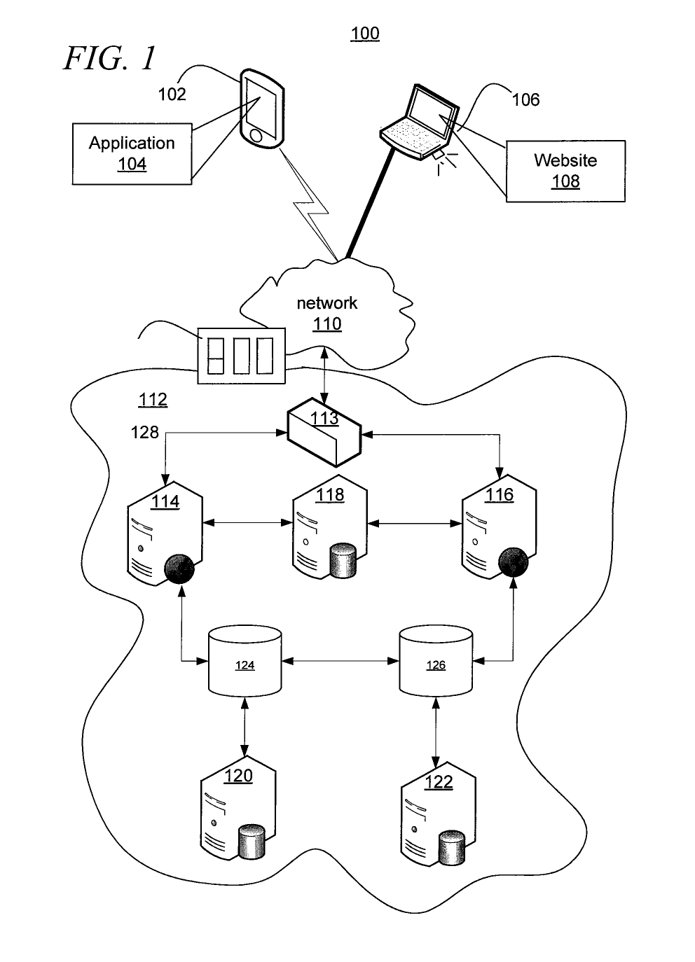

FIG. 1 is a pictorial representation of a communications system 100 for managing events in accordance with an illustrative embodiment. The communications system 100 may include any number of hardware and software components, including, but not limited to, devices, equipment, systems, modules, operating systems, kernels, and applications. In one embodiment, the communications system 100 may include a wireless device 102, an application 104, a laptop 106, a website 108, a network 110, and a cloud system 112.

The cloud system 112, or network may similarly include any number of components. In one embodiment, the cloud system 112 may include a load balancer 113, web servers 114 and 116, storage 118, 120, and 122, and databases 124, and 126. Each of the devices, systems, and equipment of the communications system 100 may include any number of computing and telecommunications components, devices or elements which may include processors, memories, caches, busses, motherboards, circuits, ports, interfaces, cards, converters, adapters, connections, transceivers, displays, antennas, and other similar components that are not described herein for purposes of simplicity.

The wireless device 102 and the laptop 106 are examples of communications and computing devices that may be utilized to receive user input regarding problems and events and similarly communicate information regarding the problems and events in real-time as updated. Other communications and computing devices may similarly be utilized, such as voice over Internet Protocol telephones, soft phones, chatting applications, faxes, tablet computers, desktop computers, terminals, or so forth. The wireless device 102 and a laptop 106 may utilize the application 104, the website 108, an application-specific integrated circuit (ASIC), digital logic, an add-on, an operating system, or other hardware or software and to perform the communications as herein described. For example, a graphical user interface may be displayed to the user visually or audibly for receiving user input and selections and providing information and details to the respective users.

The software embodied by the application 104 and the website 108 allows users to create, store, communicate, and view reports of any of the different communications tools of the event management software. The communications system 100 facilitates communications between parties that are remotely located or on the move.

In one embodiment, the network 110 represents an Internet connection available to multiple parties. The network 110 represents communications through the application 104, the website 108, mobile phones, landline telephones, radios, and other mobile communications devices to a centralized system, such as the cloud system 112. The different components of the communications system 100 may be configured to communicate using wireless communications, such as satellite connections, WiFi, WiMAX, CDMA wireless networks, and/or hardwired connections, such as fiber optics, T1, cable, DSL, high speed trunks, and telephone lines. Any number of communications architectures including client-server, network rings, peer-to-peer, n-tier, application server, or other distributed or network system architectures may be utilized.

The wireless devices 102 may communicate with a wireless network (that is considered to be part of the network 110) using communications protocols, such as time division multiple access (TDMA), code division multiple access (CDMA), global systems for mobile (GSM) communications, personal communications systems (PCS), WiFi, WLAN, WiMAX, or other frequently used cellular and data communications protocols and standards. The wireless devices 102 may include smart phones (e.g. iPhones, Android devices, etc), cellular phones, Blackberry® devices, personal digital assistances (PDA), mp3 players, laptops, evolution data optimized (EDO) cards, multi-mode devices, and other wireless communication devices and elements. In one embodiment, the described systems and methods may take advantage of a WiFi network that is already provided for employees and guests of the facility.

Communications within the communications system 100 may also occur on any number of networks which may include wireless networks, data or packet networks, cable networks, satellite networks, private networks, publicly switched telephone networks (PSTN), the network 110, or other types of communication networks. A communications network is infrastructures for sending and receiving messages and signals according to one or more designated formats, standards, and protocols. The network 110 of the communications system 100 may represent a single communication service provider or multiple communications services providers. For example, the network 110 may include any number of public, private, and virtual networks. The features, services, and processes of the illustrative embodiments may be implemented by one or more components of the communications system 100 independently or as a networked implementation.

The cloud system 112 represents a cloud computing environment and network utilized to deliver computing as a service. The cloud system 112 allows one or more service providers to centralize data, software, and computation for access through the application 104 and the website 108 which communicate with the cloud system 112 through the network 110 through a wired or wireless connection. The cloud system 112 may prevent unauthorized access to data stored in storages 118, 120, and 122, the databases 124 and 126, and other components of the club system 112. In addition, service providers may more quickly roll out the event management system and software herein described with easier manageability and less maintenance. In addition, the cloud system 112 allows the overall communications system 100 to be scalable for quickly adding and removing service providers as needed. Communications with the cloud system 112 may utilize encryption, secure tunnels, handshakes, secure identifiers, firewalls, specialized software modules, or other data security systems and methodologies as are known in the art.

The load balancer 113 is one or more devices configured to distribute the workload of the event management process and software across the cloud system 112 to optimize resource utilization, throughput, and minimize response time and overload. For example, the load balancer 113 may represent a multilayer switch, database load balancer, or a domain name system server. The load balancer 113 may facilitate communications and functionality (e.g. database queries, read requests, write requests, etc) between the wireless device 102 or the laptop 106 and the cloud system 112.

In one embodiment, the web servers 114 and 116 may be utilized to provide the website 108 for interfacing with users. Information received through the website 108 may be managed by the storages 118, 120, and 122 and databases 124 and 126. The Web servers 114 and 116 may communicate with the databases 124 and 126 to respond to read and write requests. The databases 124 and 126 may utilize any number of database architectures and database management systems (DBMS) as are known in the art.

In one embodiment, the communications system 100 or the cloud system 112 may also include a communications management system 128 which is one or more devices utilized to enable, initiate, route, and manage communications between one or more telephonic and computing devices. The communications management system 128 may include one or more devices networked to manage the network 110 and cloud system 112. For example, the communications management system 128 may include any number of servers, routers, switches, or advanced intelligent network devices. The network 110 sends and receives the electronic signals through any number of transmission mediums. The communications network 110 may include various fiber optics, cables, transmission towers, antennas, or other elements for transmitting voice communications to the connected telephonic devices. In one embodiment, the communications management system 100 may manage the event management software and services provided to the wireless device 102 and laptop 106. For example, the communications management system 128 may include a host application or logic that communicates with the application 104. The communications management system 128 may also manage the website 108 and corresponding communications and data management.

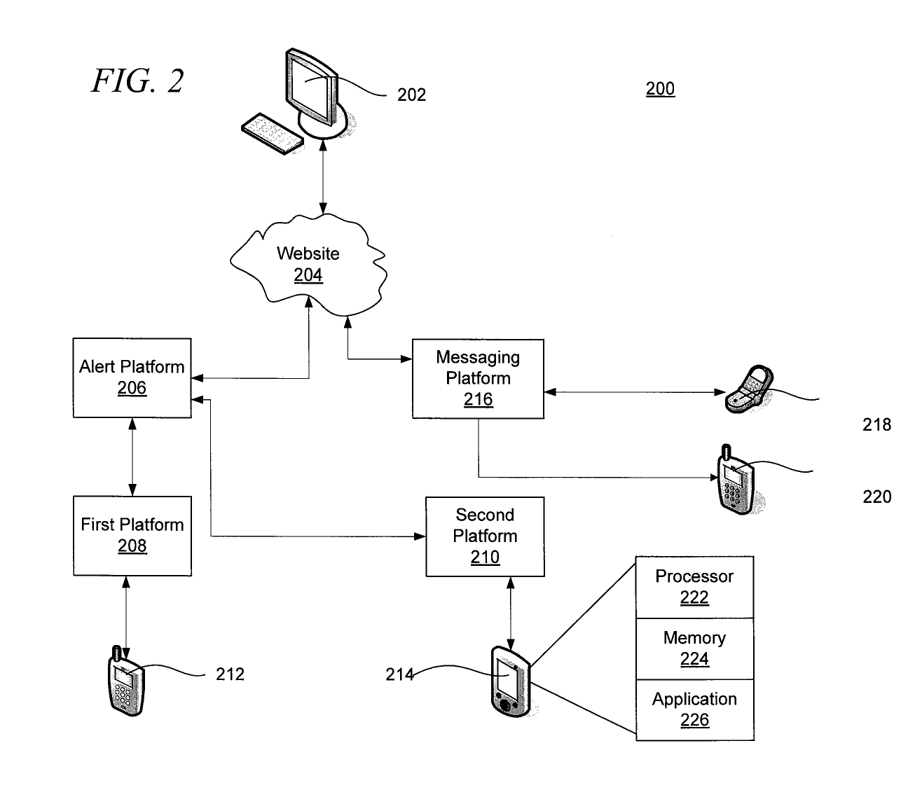

FIG. 2 is a pictorial representation of an event management system 200 in accordance with an illustrative embodiment. The event management system 200 may include any of the components previously described for the communications system 100 of FIG. 1. In one embodiment, the event management system 200 may include a computer 202, a website 204, an alert platform 206, a first platform 208, a second platform 210, wireless devices 212 and 214, a messaging platform 216, and wireless devices 218 and 220. In addition, any of the computer 202, and wireless devices 212, 214, 218, and 220 may include a processor 222, a memory 224, and an application 226 as are shown for the wireless device 214.

The event management system 200 may be utilized to report problems, create events, and manage numerous events simultaneously until resolved. The computer 202 represents a computing or communications device utilized by a user. For example, the computer 202 may be utilized by a front desk clerk or administrative staff of the service provider (e.g. hotel). The user may utilize a web browser or other application on the computer 2022 access the website 204. The website may be a portal or interface that functions as a central point of access to the event management system and information on the Internet or an intranet. The website may be accessed from any computing or communications system or device enabled to communicate through a network connection. For purposes of FIG. 2, the website represents the back-end systems, cloud network, servers, databases, and other systems, equipment, and devices that may be utilized to create, manage, track and report on events as herein described.

The website 204 may communicate with the alert platform 206 to generate application alerts that are communicated to and displayable to the wireless devices 212 and 214. In one embodiment, the alert platform 206 may be a software module or application configured to send application alerts to the first platform 208 and the second platform 210. For example, the alert platform 206 may be a program such as urban airship. Platforms compatible with Apple, Google (e.g. Android), AT&T, Verizon, Sprint, Clear, MetroPCS, and other service providers, companies, and providers may also be utilized. In one embodiment, the user or the wireless devices 212 and 214 that communicate with the alert platform 206 may be registered or assigned an identification by the alert platform 206 in order to properly route alerts that are created based on new or existing events.

The first platform 208 and the second platform 210 represent platforms that may be required to communicate with the wireless devices 212 and 214, respectively. For example, the first platform 208 may represent an alert platform utilized for android devices and the second platform 210 may represent an alert platform utilized for Apple devices, such as iPhones, iPods, and iPads. The first platform 2 away and the second platform 210 are representative of a multitude of platforms that may be utilized for communicating public or proprietary alert systems and receiving updates from the associated wireless devices 212 and 214, and users.

The processor 222 is circuitry or logic enabled to control execution of a set of instructions. The processor 222 may be microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor 222 may be a single chip or integrated with other computing or communications elements.

The memory 224 is a hardware element, device, or recording media configured to store data for subsequent retrieval or access at a later time. The memory 224 may be static or dynamic memory. The memory 224 may include a hard disk, random access memory, cache, removable media drive, mass storage, or configuration suitable as storage for data, instructions, and information. In one embodiment, the memory 224 and processor 222 may be integrated. The memory may use any type of volatile or non-volatile storage techniques and mediums.

The wireless device may utilize hard keys or soft keys for receiving user input. Hard keys are dedicated buttons or interface elements hard-coded for a single, unique, and consistent purpose. Examples of hard keys include the 12-buttons of the traditional alpha-numeric keypad, the send/end keys commonly found on mobile phones, and buttons to initiate or end a speakerphone function. Soft keys are programmable buttons or interface elements. Soft keys are usually located alongside a display device and may perform different functions dependent on the text shown near the soft keys on the display. For example, soft keys may also be touch screen indicators, buttons, icons, or so forth. Examples of soft keys may include directories and speed dial lists.

The application 226 is a specialized program or app configured to communicate with the website 204 or backside of the event management system 200 as further shown in FIG. 1. The application 226 may include a graphical user interface for displaying data, including events and the associated information. In one embodiment, the user may open the application 226 on the wireless device 214 to create a new event while performing a grounds check of a facility. For example, the user may discover a sprinkler head that is broken, causing water to spill onto a pathway and creating a dangerous area or at the very least a nuisance. The new event may specify the problem, problem type, location, and assigned response group (including individuals that are notified). In one embodiment, the application 226 may utilize the location of the user determined utilizing a global positioning system, wireless triangulation, or other methods to input the location of the problem. This may be useful for problems and their associated locations that are not easily identified.

In one embodiment, the wireless device 212 may be utilized by a manager of the facility. In response to the user utilizing the wireless device 214 submitting a new event through the application 226, an alert may be routed through the event management system 200 to the wireless device 212 to keep the manager informed of the situation as it is addressed or resolved. In addition, based on viewing the alert, the manager may further input details regarding how the event is to be resolved. For example, the manager may utilize an application to indicate that both maintenance and grounds keeping teams work on the problem together and that she is notified as soon as the event is closed or tasks associated with the event are finished.

The messaging platform 216 is utilized to manage text, voice, email, chat, and other messages that need to be sent based on instructions or commands from the website. In one embodiment, the messaging platform 216 represents a platform or application program interface, such as the tropo messaging platform. The messaging platform 216 may also represent cellular modems, phones liked to the computer network, soft phones, or other devices or modules for providing the messaging or calling functionality. In addition, network links may be utilized to send and receive messages and phone calls from web applications. In one embodiment, the event information may include interactive links for dialing or sending a message to a department (individual or group call), manager, or the guest. For example, event calls may be placed utilizing interactive voice response system to read the information associated with an event to the user and receive user input through selections or voice commands.

In one embodiment, the messaging platform 216 may be utilized to send alerts or messages to the wireless devices 218 and 220, that may be incapable or not currently running the application 226. For example, the wireless device 218 may not be a smart device configured to execute the application 226. However, the wireless device 218 may still be configured to receive text messages for creating, managing, and reporting events. In another embodiment, the messaging platform 216 may be configured to send a message to the wireless device 214 in response to the application 226 experiencing errors or other problems preventing the wireless device 214 from receiving alerts through the application 226.

In another embodiment, the event management system 200 may be configured to be integrated with or communicate with other systems, such as a hotel property management system interface. The other system(s) may be utilized to access information regarding guest names, room occupation status, and other information.

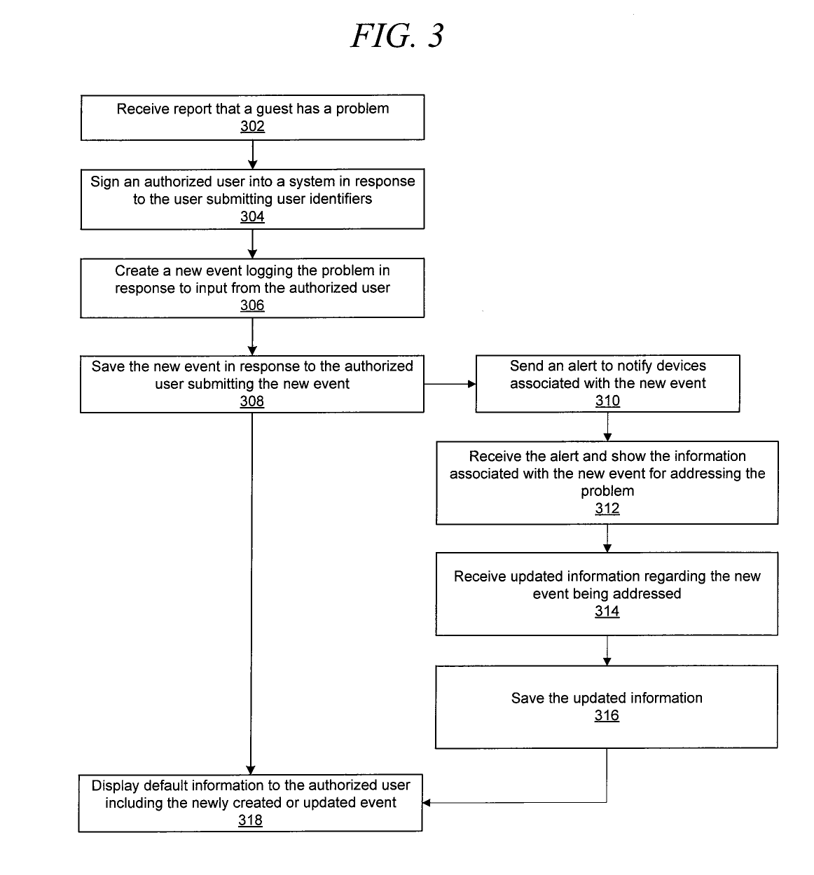

FIG. 3 is a flowchart of a process for managing events in accordance with an illustrative embodiment. The process of FIG. 3 may be implemented by an event management or communication system. In one embodiment, the system may utilize a number of computing and communications devices. For example, communications may occur through a website, applications, and the necessary back-end devices, including networks, servers, databases, specialized applications, and other logic, hardware, and software components.

The process of FIG. 3 may begin with. The system receiving a report that a guest has a problem (step 302). In one embodiment, the report may be received directly from the guest by an individual representing the service provider. For example, the just may be staying at a hotel and may report that she wants new sheets directly to a front desk clerk. In another embodiment, the report may be received through an electronic message, such as a text message, voice mail system, e-mail, chat, message, application message, or other form of messaging. For example, the service provider may make available an application that allows the guest to submit complaints, issues, or problems for the service provider. For example, the guests may have signed up for a table at a convention and by submitting the report may be requesting that power and communications services be made available to plugs and ports associated with the table.

Next, the system signs an authorized user into the system in response to the user submitting user identifiers (step 304). In one embodiment, the system is a website accessed by a user through a computing or communications device, such as a desktop computer, laptop, or tablet. The authorized user may have previously been assigned a username, password, nickname, account number, or other identifying information. The authorized users may include administrators, employees, and contractors employed by the service provider.

In one embodiment, in response to submitting a username and password, the authorized user, such as the front desk clerk, may be signed into the website and information designated for a particular facility, such as a hotel. The user identifiers may also identify a particular facility or event. For authorized users that are associated with numerous facilities or events, the system may request that the user selects a facility or event identifier. For example, a facility identifier may identify a particular name and location of the facility utilizing a drop-down menu presented by the website.

Next, the system creates a new event logging the problem in response to input from the authorized used (step 306). In one embodiment, the new event is generated in response to a user selecting an icon or button to create a “New Event.” The new event is associated as being logged by the authorized user in response to the user signing into the system during step 304. During step 306 the authorized user enters details of the new event. In one embodiment, the authorized user may be a front desk clerk that enters a guest name, department, event code, additional details and notes, parties to be notified, and a selection of communications types to be utilized. For example, the new event may specify room number: 122, guest name: Jeanette Robinson, department: maintenance, event code: heater guest room, extra details: “Guest states that her heater is not working correctly. She is cold.”, and contact method: alert maintenance wireless device. In another embodiment, the authorized user is an event coordinator that creates the event specifying the problem, individual or group assigned to address the problem, timeframe for addressing the problem, location, contact and verification information, and other information.

Next, the system saves the new event in response to the authorized user submitting the new event (step 308). In one embodiment, the new event is received through a website and saved by a database. For example, the new event may be saved as an entry in a MySQL database table utilizing a right request, or other command.

Next, the system sends an alert to notify devices associated with the new event (step 310). In one embodiment, the devices may include wireless devices of authorized users in or throughout the facility or event. The new event may specify specific users or devices that are notified via alert when a new event is created or based on the type of new event. The authorized user that generates the report may specify individuals are devices that are to receive the alert associated with the submission of the new event. In another embodiment, logic, may specify individuals and devices that receive alerts, such as management or supervisors and teams or organizations working within a facility. For example, for new alerts that include maintenance issues, the alert may be sent to maintenance personnel as an application specific alert, as a text message, or as an automated call. In one embodiment, the system may internally send a message or command to a program, interface, module or transceiver to send the alert. For example, a messaging program, such as Urban Airship, may be utilized to send the alert.

Next, the device receives the alert and shows the information associated with the new event for addressing the problem (step 312). In one embodiment, the device may be configured to play or display and audio, visual, or tactile indicator (vibration) to the user in response to receiving the alert. The alert may be routed to the device in response to the user being signed in to an application or website tracked by the system. In another embodiment, the alert may be routed utilizing a hardware or software identifier, such as an IP address, IMEI, username, phone number, or other identifier known in the art.

In one embodiment, the alert may automatically display the information associated with the new event. For example, the alert may display the problem, location, party assigned to fix the problem, timeline, and other information. In another embodiment, the user may be required to select the alert in order to view the information associated with the new event. For example, the user may utilize a touchscreen, voice command, or button of a wireless device to select the alert for the new event upon which the wireless device may display the information for resolving the problem, and reporting back

Next, the system receives updated information regarding the new event being addressed (step 314). The updated information may be received from one or more of the devices that received the alert or other devices that may access the system. For example, the updated information may be received through an application, website, e-mail, or message that is received by the system. In one embodiment, the individuals addressing the problem associated with the event may be required to select whether the problem is resolved or ongoing for further tracking, managing, and reporting on the new event.

In one embodiment, the updated information may be updated for display and logging. With the system. The updated information may specify how, when, and where the problem was addressed and the final resolution, or ongoing steps. For example, the updated information may specify a maintenance worker that replaced a heating coil in room number 122 for a guest. The updated information may be received by the system a number of times in response to one or more users addressing the problem individually or as a team. The updated information may also be utilized to send another alert or update to the users or devices associated with the new event.

Next, the system saves the updated information (step 316). The updated information may be saved as part of the new event that was created. For example, the database record may be updated with the updated information. In addition, in response to the new event being marked as resolved or completed, the new event may be closed and necessary reporting information may be sent through one or more alerts or messages.

Next, the system displays the fall information to the authorized user, including the newly created or updated event (step 318). In one embodiment, the system may be updated to indicate that the new event is closed or inactive. As a result, the new event may not be displayed to a user on a homepage or events page of the website or application.

Likewise, in response to receiving the new event after submission during step 308, the system may display the new event so that a number of authorized users are aware that there is a problem and that the problem is being addressed by communications through the system and event management software.

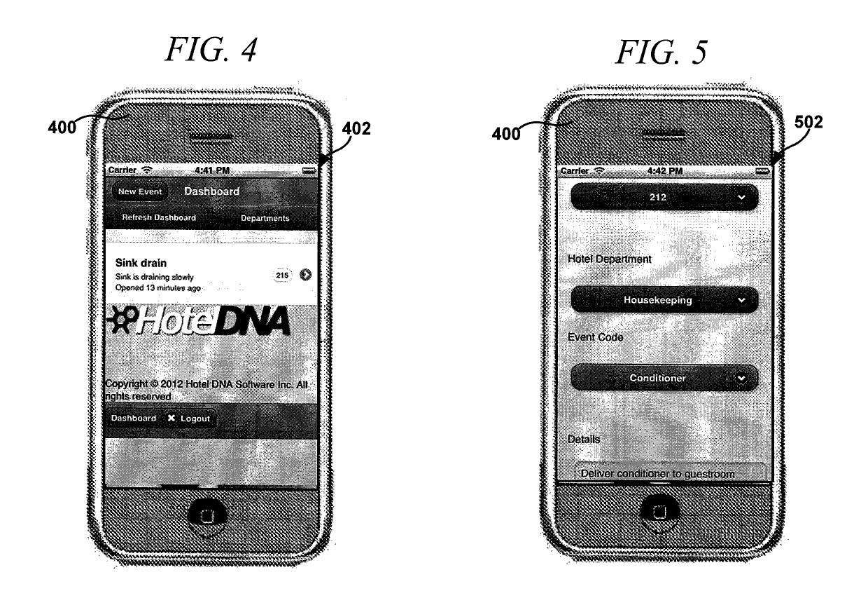

FIGS. 4 and 5 are a pictorial representation of graphical user interfaces 402 and 502 in accordance with an illustrative embodiment. The graphical user interfaces 402 and 502 may be displayed by a wireless device 400 representing one or more communications or computing devices. The graphical user interfaces 402 and 502 may be generated by an application being executed by the wireless device 400. In another embodiment, the graphical user interfaces 402 and 502 may represent a web browsing application accessing a particular website.

The graphical user interface 402 may illustrate a dashboard view for displaying events and other relevant information. For example, the graphical user interface 402 indicates a new event entitled “sink drain” was created thirteen minutes ago. The event indicates a guest in room number 215 has a problem with the sink draining slowly. Although not shown, the graphical user interface 402 may also show the department assigned or currently addressing the problem associated with the event. The graphical user interface 402 may also include a new event button for creating a new event.

The graphical user interface 502 of FIG. 5 may similarly be configured to receive, edit, or display information regarding an event. In one embodiment, the graphical user interface 502 may allow the user to specify a room number associated with the problem, a hotel department assigned to resolve the problem, and an event code. In one embodiment, the graphical user interface 502 may allow the user to utilize drop-down menus customized for the service provider or facility to make selections and provide user input. In addition, additional fields or menus of the graphical user interface 502 may allow the user to enter custom text, numbers, data, pictures, audio files or other information. For example, a user creating an event utilizing the graphical user interface 502, such as finding a broken bed, may take a picture of the broken bed for inclusion wherein creating the new event. An audio file may be attached to provide specific instructions, or information without having to type every single detail utilizing the wireless device 400.

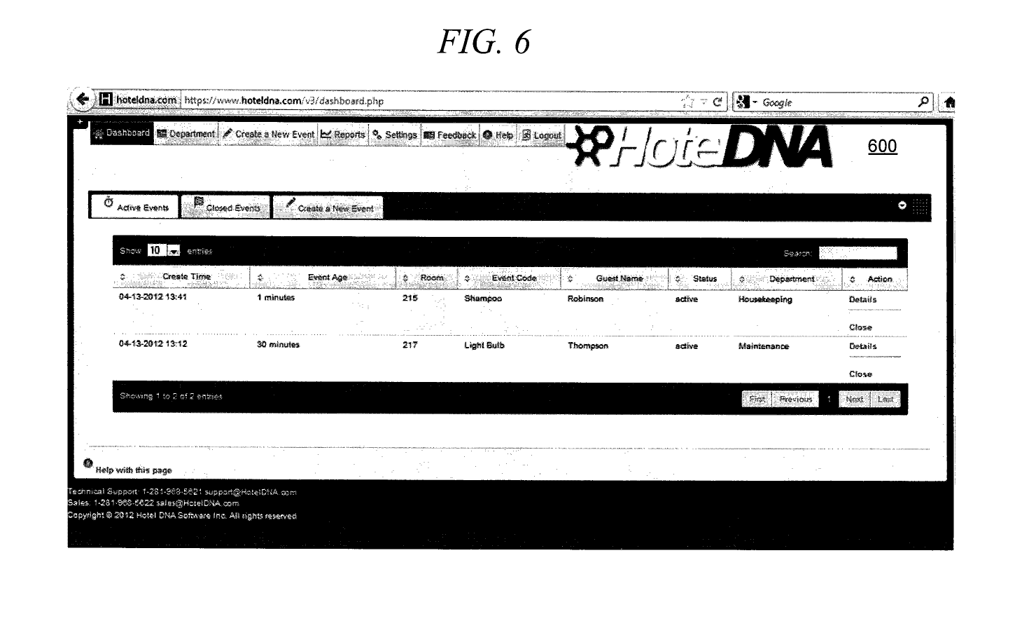

FIGS. 6-8 are pictorial representations of graphical user interfaces 600, 700, and 800 in accordance with an illustrative embodiment. The information of the graphical user interfaces 600, 700, and 800 is stored privately and may only be accessible or visible to authorized users that have logged into the website (e.g. utilizing Internet Explorer, Firefox, Chrome, Safari, Opera, etc) or application. One or more administrators may set preferences for allowing users access to the events and other information managed and accessed through the graphical user interfaces 600, 700, and 800. The events are organized by service provider to maintain privacy. The website and applications may store all information indefinitely or may be set to purge information after a pre-defined time period for liability purposes.

The graphical user interface 600 of FIG. 6 also shows a dashboard viewing mode. In one embodiment, the user may be able to review active events, see closed events, or creating new events as needed from the. In addition, the entries or events may include interactive elements, such as hyperlinks that allow the user to view additional details or information. The graphical user interface 600 may also display information for events including creation time, event age, room or location, event code, guest name if applicable, status (e.g. active, closed, in-process, etc), department, and action details.

The graphical user interface 600 may allow a user to perform searches of events or other information. The settings may be utilized to customize information, such as username, password, alert and message information and preferences, assigned department and other applicable information. The graphical user interface 600 may also be utilized to solicit feedback regarding performance and functionality of the website and applications utilized for event management.

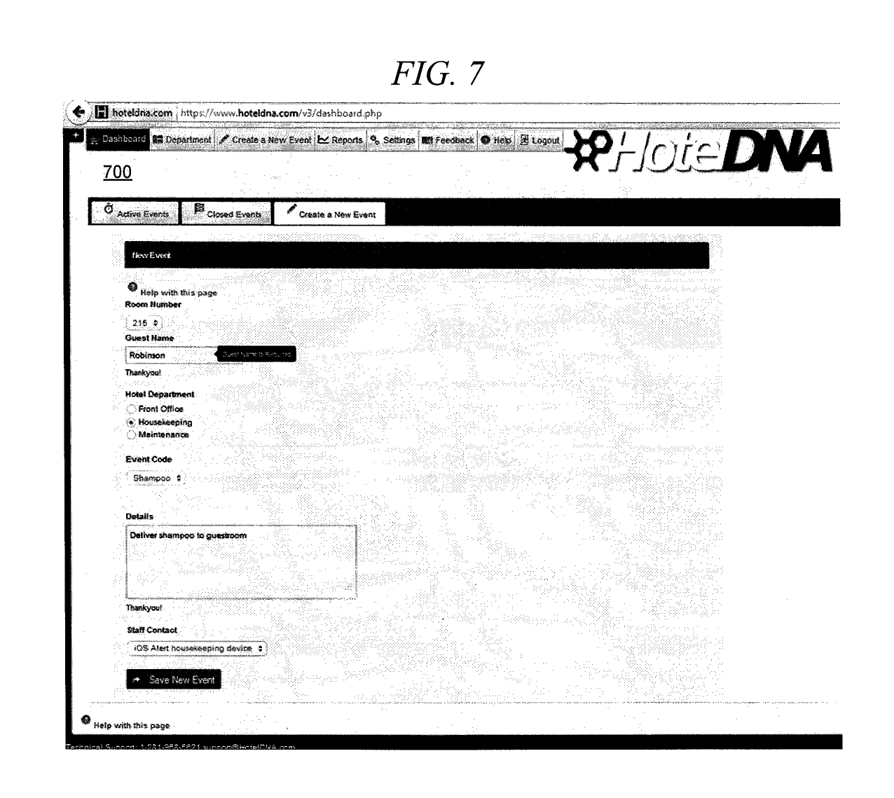

Turning now to FIG. 7, the graphical user interface 700 illustrates information and selections being received for creating a new event. The authorized user is able to provide user input utilizing a number of drop-down menus, pre-populated fields, and custom fields before saving the new event. For example, the user may utilize the graphical user interface 700 to provide custom details regarding the problem or resolution.

In one example, the graphical user interface 700 may display room information including the rooms that have been created for or associated with the service provider/property. The rooms may include specific roon numbers and other entries, such as common area, pool, parking lot, and so forth. The department shows only the departments that have been created for the service provider. Common examples for a hotel include housekeeping, maintenance, and administration. For events such as conferences, departments may include security, food service, maintenance and moving, communications services, public relations, billing, and supervisory. Event codes may be short descriptions of possible problems that may be logged as events, such as “Heater not working” or “Slip and Fall.” The event codes may also include an option indicating the correct code is not listed for receiving a custom entry. The event codes may be added by default or customized for each facility. In one embodiment, new event codes may be generated by users in response to a manual entry a first time. For example, once light bulb replacement has been listed it may be added to a drop down menu for additional users.

The events details provide a more in-depth description of the event being logged. The user may add any instructions, information, or details needed to this field. In one embodiment, the event details may be provided with information corresponding to the event code. For example, in response to receiving an event code indicating light bulb out, the event details may be pre-populated with the text “Light bulb location?” so that the user may provide more information regarding the exact location of the light bulb for the employee that addresses the issue.

Staff contact may be pre-populated based on multiple factors including the event code. The associated employees may be contacted through personal or service provider provided devices. For example, a number of employees may have registered a cell phone or smart phone to receive text messages or application alerts. Additionally, automatic calls or email messages may be utilized. In one embodiment, a username may be utilized to send an alert through the application utilizing an iOS, Android, Google, or other known or utilized framework or username. In another embodiment, nicknames may be associated with communications device, such as maintenance so that the devices may be passed from person to person at the end of a shift while still receiving alerts. It may be very helpful to communicate with a department without knowing who is on shift at the time. In another embodiment, a calendaring program, clock-in system, tracking system, or other system or logic may be utilized to determine who to contact. For example, logic may specify the device or party to be contacted based on time of day, location, and event code.

Once the new event is saved a number of things may automatically occur. For example, the new event may be saved in a database with all of the associated information. The system may then determine the contact method and information that was selected and communicate utilizing automated call, email, text message, application alert, or so forth. As previously described, some of the alerts or messages may be sent utilizing 3^{rd} party systems or platforms. Upon successful communication of the message the event may be separately logged in a database that keeps track of event histories. The event history may be tracked and sent to designated users based on pre-defined triggers, such as time periods, resolved events, and so forth. The system may also send repeat messages or notifications to the same users or additional users in response to receiving the event (e.g. the administrator may be notified of all guest and employee accidents). As a result, the administrator may be able to stay informed of all problems that are noted as important according to preferences stored in the settings. Based on the messages, notifications, or alerts the problem(s) associated with the event may be taken care of with the event or tasks associated with the event being closed. All updates to the events are synched across multiple devices to ensure that things are not completed multiple times and in order to ensure efficiency. The settings of the system may allow a completed message to be sent when the event is closed.

In one embodiment, the graphical user interface 700 may be configured to receive a user phone number, email address, or other contact information for notifying the user once the problem associated with the event has been resolved. For example, the information may specify the type of communication (phone call, text message, email, chat message) that is to be sent to the guest indicating the problem or issue associated with the event has been addressed. In one embodiment, the application may be downloaded by customers to present a custom interface for retrieving additional information, reporting problems, and receiving addition services, such as concierge services. For example, the guest may report that his sheets need to be changed. The front desk may log the problem through the graphical user interface 700 to create a new event. When housekeeping completes the event and the event is marked as completed, the event management system may sent a text message to the designated number indicating “Your item for room 212 has been completed! Have a great stay at the Fiesta Motel in Las Vegas”

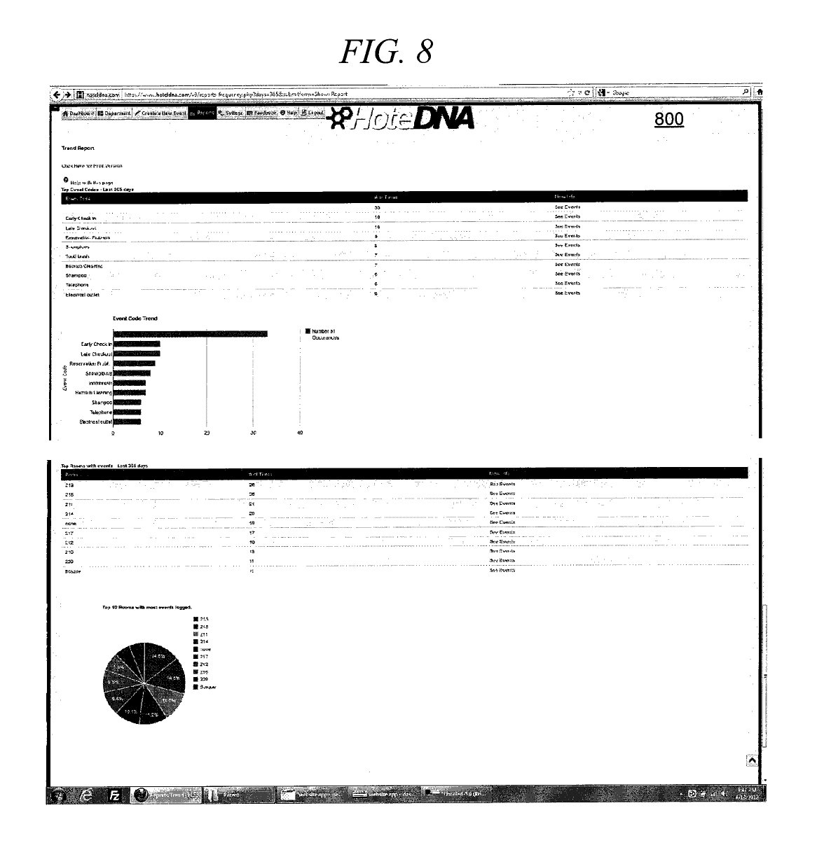

Turning now to FIG. 8, the graphical user interface 800 illustrates one of many reports that may be displayed to the user. In one embodiment, the graphical user interface 800 may display the events that are most frequently generated for the service provider, such as a hotel. For example, the most frequent events may include early check-in, late checkout, reservation problem, snow removal issues, forgotten toothbrush, bathtub cleaning needed, request for shampoo, telephone issues, and electrical outlet problems. The graphical user interface 800 may display the number of occurrences and details that may help the service provider prevent future occurrences or preliminarily address issues. For example, the facility may find that it is cheaper to leave out a toothbrush for all rooms rather than reply to all requests. Additionally, the report may help indicate when equipment or facilities, such as telephones or wiring need to be replaced to prevent problems including complaints and the associated repair costs.

Reporting may also include a running computer process that uses statistical analysis to determine ‘events’ that are anomalies and do not fit into the current trend of the facility. The system or website may then send a notification (e.g. email, text, chat, voice call, notification, electronic message, etc.) to a managing user or administrator so they are alerted to the unusual event, utilizing a “Smart Event Agent.” In one embodiment, daily flash reports may be generated for administrators or managers showing all key events from the previous day as well as monthly trends for the service provider. The historical events may be search utilizing any pre-set information, criteria, or customized information. The reports may also show the rooms, sections, or departments that have experienced or resolved the most events. The information from the reports may be utilized to perform service training and improvements to help the service provider keep guests happy.

The previous detailed description is of a small number of embodiments for implementing the invention and is not intended to be limiting in scope. The following claims set forth a number of the embodiments of the invention disclosed with greater particularity.

What is claimed:

1. A method for managing events, the method comprising:
receiving a report of a problem from an authorized user, creating a new event logging the problem in response to receiving submission of the new event;
saving the new event in a database in response to receiving submission of the new event from the authorized user, the new event including at least information about a location of a problem, a department assigned the event, an event code, and a contact method for one or more users associated with the new event;
sending an alert utilizing the contact method to notify the one or more users associated with the new event;
receiving updated information regarding the new event; and
saving the updating information in the database as associated with the new event.

2. The method according to claim 1, wherein the report is received electronically through a website or an application installed on an electronic device.

3. The method according to claim 1, further comprising:
determining the authorized user is authorized to submit the new event.

4. The method according to claim 3, wherein the new event and the authorized user are associated with a facility.

5. The method according to claim 2, wherein the report is received through a template provided to the authorized user through the website or the application.

6. The method according to claim 1, further comprising:
displaying a plurality of events and a status associated with each of the plurality of events.

7. The method according to claim 1, wherein the alert is sent according to user preferences for each of a plurality of authorized users.

8. The method according to claim 1, wherein the one or more users include devices dedicated for receiving alerts.

9. The method according to claim 1, wherein the website and the application communicate with the database through a cloud network

10. The method according to claim 1, further comprising:
sending out a second message indicating the new event is closed in response to the new event being resolved and a status of the new event being set as closed.

11. A system for managing events, the system comprising:
a server configured to interface with a website or applications installed on a plurality of electronic devices, the server is configured to receive a report of a problem from an authorized user, create a new event associated with the problem in response to the authorized user submitting the new event, new event including at least information about a location of a problem, a department assigned the event, an event code, and a contact method for one or more users associated with the new event, and send an alert utilizing the contact method to notify the one or more users associated with the new event; and
at least one database in communication with the server, the database is configured to store the new event in the database in response to receiving submission of the new event from the authorized user, wherein the at least one database stores updates for the new event in response to submission through the website or applications.

12. The system according to claim 11, wherein the server includes a plurality of alert platforms for sending alerts to electronic devices executing one of the applications.

13. The system according to claim 11, wherein the server includes a messaging platform configured to sent messages to electronic devices that are unable to receive alerts through the applications.

14. The system according to claim 11, wherein the server and the database are part of a cloud system, and wherein the new event and the authorized user are associated with a facility.

15. The system according to claim 11, wherein the server communicates information to the applications and the website for displaying a plurality of events and a status associated with each of the plurality of events.

16. A server for managing events comprising:
a processor for executing a set of instructions; and
a memory for storing the set of instructions, wherein the set of instructions are configured to:
receive a report of a problem from an authorized user, create a new event logging the problem in response to receiving submission of the new event, save the new event in a database in response to receiving submission of the new event from the authorized user, the new event including at least information about a location of a problem, a department assigned the event, an event code, and a contact method for one or more users associated with the new event, send an alert to notify the one or more users associated with the new event, the alert, receive updated information regarding the event; and save the updating information as associated with the event.

17. The server according to claim 16, wherein the set of instructions are further executed display a plurality of events and a status associated with each of the plurality of events.

18. The server according to claim 16, displaying a report regarding the plurality of events for a time period.

19. The server according to claim 16, wherein the alert is sent to a plurality of users utilizing distinct device types.

20. The server according to claim 16, wherein the server includes a plurality of alert platforms for sending alerts to electronic devices executing one of the applications, and a messaging platform configured to sent messages to electronic devices that are unable to receive alerts through the applications.
